(19) United States
(12) Patent Application Publication
(10) Pub. No.: US 2013/0229598 A1
(43) Pub. Date: Sep. 5, 2013

(54) LIGHT-EMITTING ELEMENT AND DISPLAY DEVICE

(71) Applicant: Tsuyoshi Kamada, Osaka-shi (JP)

(72) Inventor: Tsuyoshi Kamada, Osaka-shi (JP)

(73) Assignee: SHARP KABUSHIKI KAISHA, Osaka-shi, Osaka (JP)

(21) Appl. No.: 13/884,351

(22) PCT Filed: Nov. 9, 2011
(86) PCT No.: PCT/JP2011/075835

§ 371 Date: May 9, 2013

(30) Foreign Application Priority Data
Nov. 10, 2010 (JP) 2010-252011

(51) Int. Cl. H05B 33/14

(52) U.S. Cl. CPC H05B 33/145
USPC 349/69; 313/507; 362/84

(57) ABSTRACT

A light-emitting element includes a base substrate and a light-emitting layer that is formed on the base substrate. The light-emitting layer includes at least a fluorescent material that absorbs excitation light with a predetermined wavelength band and produces light with a wavelength band different from the predetermined wavelength band, and a light non-transmission amount change material that has characteristics in which a ratio of a light non-transmission amount to a light entrance amount of excitation light decreases with an increase in the light entrance amount.

### TECHNICAL FIELD

The present invention relates to a light-emitting device and a display device.

Priority is claimed on Japanese Patent Application No. 2010-252011, filed Nov. 10, 2010, the content of which is incorporated herein by reference.

### BACKGROUND ART

In the past, display devices that excite a fluorescent body by energy rays such as X rays, ultraviolet light, and visible light and perform display using the light causing fluorescence have been known. For example, PTL 1 discloses a display device that uses a fluorescent body excited by an electron ray. In this display device, an uneven structure is formed on the surface of the fluorescent body. When the electron ray is emitted from the outside, the fluorescent body is excited and light is emitted. However, at this time, when the amount of energy of the electron ray is equal to or greater than a predetermined threshold value, a luminescence amount increases supralinearly. As disclosed in PTL 1, “it is considered that a plurality of carriers are produced by forming the uneven structure on the surface of the fluorescent body and the intensity of luminescence emitted by a luminescent center intentionally doped by the carriers increases, and the intensity of luminescence for which an impurity or a potential defect occurring during manufacture is the luminescent center increases, and accordingly, it is considered that the luminescence amount increases supralinearly when the amount of energy of the electron ray is equal to or greater than the threshold value.”

In the display device disclosed in PTL 1, since the electron ray is used to excite the fluorescent body, it is necessary to maintain a vacuum state in the entire luminescent system inside the device. However, when the vacuum state is attempted to be maintained in the display device, many problems may arise. For example, the device may be of a heavy weight, thinning the device may be difficult, and the manufacturing process may become complicated. Even when a fluorescent body excited by light is used for the display device, the uneven structure is formed on the surface of the fluorescent body, and thus carriers are not produced. Therefore, the superalinear luminescence does not occur.

On the other hand, PTL 2 below discloses a liquid crystal display device including a backlight that emits blue light, a liquid crystal element that adjusts a transmission amount of the blue light, and a color conversion film member that includes a fluorescent material converting some of the blue light transmitted through the liquid crystal element into red light or green light. In the liquid crystal display device, the color conversion film member is disposed on the front surface side (user's side) of the liquid crystal element. That is, the liquid crystal display device uses the visible light (blue light) to excite a fluorescent member.

### CITATION LIST

### Patent Literature

PTL 1: Japanese Unexamined Patent Application Publication No. 2007-242624
PTL 2: Japanese Unexamined Patent Application Publication No. 2000-258771

### SUMMARY OF INVENTION

### Technical Problem

Since the visible light is used to excite the fluorescent member in the liquid crystal display device disclosed in PTL 2 described above, the problem of the display device disclosed in PTL 1 which uses the electron ray to excite the fluorescent body is resolved. However, there are other problems to be mentioned below.

In the liquid crystal display device disclosed in PTL 2, the color conversion film member is disposed on the front surface side (the front side when viewed from a user) of a glass substrate and a polarizing plate included in the liquid crystal element. When the liquid crystal display device is used in a television, for example, the size of a pixel is set to about 0.1 mm to about 0.3 mm, the thickness of the glass substrate is set to about 0.7 mm, and the thickness of the polarizing plate is set to about 0.2 mm. Thus, the thicknesses of the glass substrate and the polarizing plate are sufficiently greater in consideration of the size of the pixel. Therefore, for example, even when control is performed such that arbitrary pixels of the liquid crystal element enter the ON state (bright display) and the pixels near the arbitrary pixels enter the OFF state (dark display), a problem may arise in that the fluorescent body is excited with the nearby pixels which are to originally enter the OFF state (dark display) and the nearby pixels may enter the ON state (bright display). That is, erroneous lighting or the like of the pixels may occur due to parallax, and thus a problem may arise in that an image with high resolution may not be obtained.

As means for resolving the above-mentioned problem of parallax, a configuration can be considered in which the color conversion film member approximates a liquid crystal layer by disposing the color conversion film member and the polarizing plate on the rear side (the rear side when viewed from the user) of the glass substrate. In the following description, a polarizing plate that is elaborated inside a liquid crystal cell (liquid crystal element) is also referred to as an “in-cell polarizing plate.” When this configuration is used, an externally attached polarizing plate is not bounded after the liquid crystal element is manufactured, but the in-cell polarizing plate is formed on one surface of the glass substrate during a process of manufacturing the liquid crystal element. In the manufacturing process, a process of forming a liquid crystal driving transparent electrode or an alignment film is necessary after the in-cell polarizing plate is formed. Therefore, a problem of heat resistance of a polarizing layer material arises. Therefore, it may be very difficult to transfer PVA (Poly-Vinyl Alcohol) or the like normally used as the polarizing layer material. In recent years, technologies for applying and forming such a kind of polarizing layer material have been developed. However, currently, the contrast of the in-cell polarizing plate is about 10 to 100. This contrast is very lower than 20000 to 30000 which is the contrast of a general polarizing plate, and thus satisfactory contrast may not be obtained.

Further, in the liquid crystal display device disclosed in PTL 2, there is a problem of deterioration in contrast to a bright place in outside light. That is, in the liquid crystal display device disclosed in PTL 2, the visible light is used to excite the fluorescent material. Therefore, when the liquid crystal display device is used in a bright place, outside light such as sunlight or illumination light hits the fluorescent body, and thus the fluorescent body is excited. Then, since the fluorescent body emits light with the pixel to be displayed darkly, display contrast may deteriorate.

The present invention is devised to resolve the above-mentioned problems and an object of the invention is to realize a configuration in which contrast can be sufficiently ensured in a light-emitting unit and a non-light-emitting unit in a light-emitting element that includes a fluorescent body receiving excitation light and producing luminescence. Another object of the invention is to realize a display device that includes such a kind of light-emitting element and is capable of achieving high contrast display.

### Solution to Problem

(1) A first aspect of the present invention provides a light-emitting element including: a base substrate; and a light-emitting layer that is formed on the base substrate. The light-emitting layer includes at least a fluorescent material that absorbs excitation light with a predetermined wavelength band and produces light with a wavelength band different from the predetermined wavelength band, and a light non-transmission amount change material that has characteristics in which a ratio of a light non-transmission amount to a light entrance amount of excitation light decreases with an increase in the light entrance amount.

The “light non-transmission amount” mentioned in this specification is a concept including both a light absorption amount and a light reflection amount. Accordingly, the light non-transmission amount change material may have characteristics in which a ratio of a light absorption amount to the light entrance amount of excitation light decreases with an increase in the light entrance amount. Alternatively, the light non-transmission amount change material may have characteristics in which a ratio of a light reflection amount to the entrance amount decreases with an the increase in the light entrance amount of the excitation light.

(2) In the light-emitting element according to the first aspect of the invention, the light non-transmission amount change material may have characteristics in which the light non-transmission amount increases with an increase in the light entrance amount when the light entrance amount is less than a predetermined light entrance amount, and the light non-transmission amount is saturated when the light entrance amount is equal to or greater than the predetermined light entrance amount.

(3) In the light-emitting element according to the first aspect of the invention, the light non-transmission amount change material may be disposed on an excitation light incident side of at least the fluorescent material.

(4) In the light-emitting element according to the first aspect of the invention, the light non-transmission amount change material may be formed of a second fluorescent material different from the first fluorescent material, when the fluorescent material is assumed to be a first fluorescent material. A luminescence center wavelength of the second fluorescent material may be different from an absorption center wavelength of the first fluorescent material.

(5) In the light-emitting element according to the first aspect of the invention, the luminescence center wavelength of the second fluorescent material may be present in an infrared band.

(6) In the light-emitting element according to the first aspect of the invention, the second fluorescent material may be formed of a plurality of fluorescent materials including different materials. The plurality of fluorescent materials may be arranged from a side close to a light incident side to a side distant from the light incident side such that luminescence wavelengths of the fluorescent materials are lined up from a shorter wavelength side to a longer wavelength side.

(7) In the light-emitting element according to the first aspect of the invention, the light non-transmission amount change material may be formed of a photochromic material.

(8) In the light-emitting element according to the first aspect of the invention, a selection reflection layer that transmits the excitation light and at least reflects light having a center wavelength on a longer wavelength side than a center wavelength of the excitation light may be disposed between the fluorescent material and the light non-transmission amount change material.

(9) In the light-emitting element according to the first aspect of the invention, a fluorescent material layer including the fluorescent material and a light non-transmission amount change material layer including the light non-transmission amount change material may be stacked on at least one surface of the base substrate. The light-emitting layer may be formed by two layers of the fluorescent material layer and the light non-transmission amount change material layer.

(10) In the light-emitting element according to the first aspect of the invention, a first fluorescent material layer including the fluorescent material, a light non-transmission amount change material layer including the light non-transmission amount change material, and a second fluorescent material layer including the fluorescent material may be stacked on at least one surface of the base substrate. The light-emitting layer may be formed by three layers of the first fluorescent material layer, the light non-transmission amount change material layer, and the second fluorescent material layer.

(11) In the light-emitting element according to the first aspect of the invention, a light-emitting layer in which a fluorescent particle formed of the fluorescent body is dispersed inside the light non-transmission amount change material may be formed on at least one surface of the base substrate.

(12) In the light-emitting element according to the first aspect of the invention, a light-emitting layer including a fluorescent particle in which a surface of the fluorescent body is covered with the light non-transmission amount change material may be formed on at least one surface of the base substrate.

(13) A second aspect of the invention provides a display device including: a light source that emits excitation light; a light modulation element that modulates the excitation light emitted from the light source; and a light-emitting element on which the excitation light modulated by the light modulation element is incident. The light-emitting element includes a base substrate and a light-emitting layer that is formed on the base substrate. The light-emitting layer includes at least a fluorescent material that absorbs excitation light with a predetermined wavelength band and produces light with a wavelength band different from the predetermined wavelength band, and a light non-transmission amount change material that has characteristics in which a ratio of a light non-transmission amount to a light entrance amount of excitation light decreases with an increase in the light entrance amount.

(14) In the display device according to the second aspect of the invention, the light modulation element may include a liquid crystal element that is able to adjust optical transmittance of each predetermined region by applying an electric field.

(15) In the display device according to the second aspect of the invention, the light-emitting element may be disposed such that a surface on which the light-emitting layer is formed faces a side of the liquid crystal element. A polarizing plate may be disposed between the light-emitting element and the liquid crystal element.

(16) In the display device according to the second aspect of the invention, the light-emitting element may include a fluorescent material layer and a light non-transmission amount change material layer. The light non-transmission amount change material layer may be disposed on an excitation light incident side of the fluorescent material layer.

(17) In the display device according to the second aspect of the invention, the light-emitting element may include a fluorescent material layer and a light non-transmission amount change material layer. The light non-transmission amount change material layer may be disposed on an outside light incident side of the fluorescent material layer.

### Advantageous Effects of Invention

In the light-emitting element according to the present invention, it is possible to sufficiently ensure contrast in the light-emitting unit and the non-light-emitting unit. Further, the display device according to the present invention can achieve the high contrast display.

### BRIEF DESCRIPTION OF DRAWINGS

FIG. 1 is a sectional view illustrating a light-emitting element according to a first embodiment of the invention.

FIG. 2A is a graph illustrating characteristics of a fluorescent body of the light-emitting element according to the first embodiment of the invention.

FIG. 2B is a graph illustrating characteristics of an absorption layer of the light-emitting element according to the first embodiment of the invention.

FIG. 2C is a graph illustrating characteristics of the entire light-emitting element according to the first embodiment of the invention.

FIG. 3A is a sectional view illustrating a light-emitting element according to a third embodiment of the invention.

FIG. 3B is a diagram illustrating an operation of each layer in the light-emitting element according to the third embodiment of the invention.

FIG. 4A is a sectional view illustrating a light-emitting element according to a fourth embodiment of the invention.

FIG. 4B is a diagram illustrating an operation of each layer in the light-emitting element according to the fourth embodiment of the invention.

FIG. 5 is a sectional view illustrating a light-emitting element according to a fifth embodiment of the invention.

FIG. 6 is a sectional view illustrating a light-emitting element according to a sixth embodiment of the invention.

FIG. 7 is a sectional view illustrating a light-emitting element according to the sixth embodiment of the invention.

FIG. 8 is a sectional view illustrating a light-emitting element according to a seventh embodiment of the invention.

FIG. 9 is a sectional view illustrating a light-emitting element according to an eighth embodiment of the invention.

FIG. 10 is a sectional view illustrating a display device according to a tenth embodiment of the invention.

FIG. 11 is a sectional view illustrating a display device according to an eleventh embodiment of the invention.

FIG. 12 is a sectional view illustrating a display device according to a twelfth embodiment of the invention.

FIG. 13 is a sectional view illustrating a display device according to the related art.

FIG. 14 is a sectional view illustrating a display device according to a comparative example.

### DESCRIPTION OF EMBODIMENTS

### Light-Emitting Element According to First Embodiment

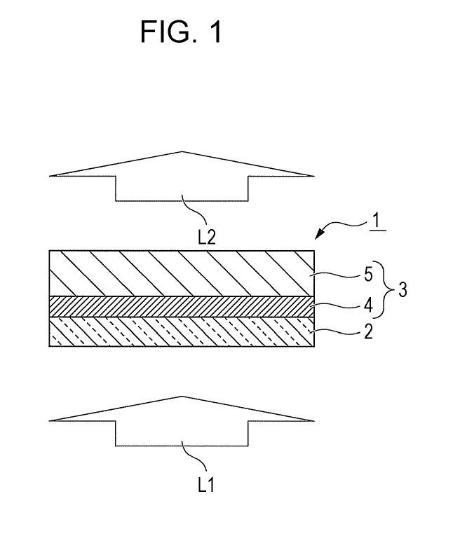

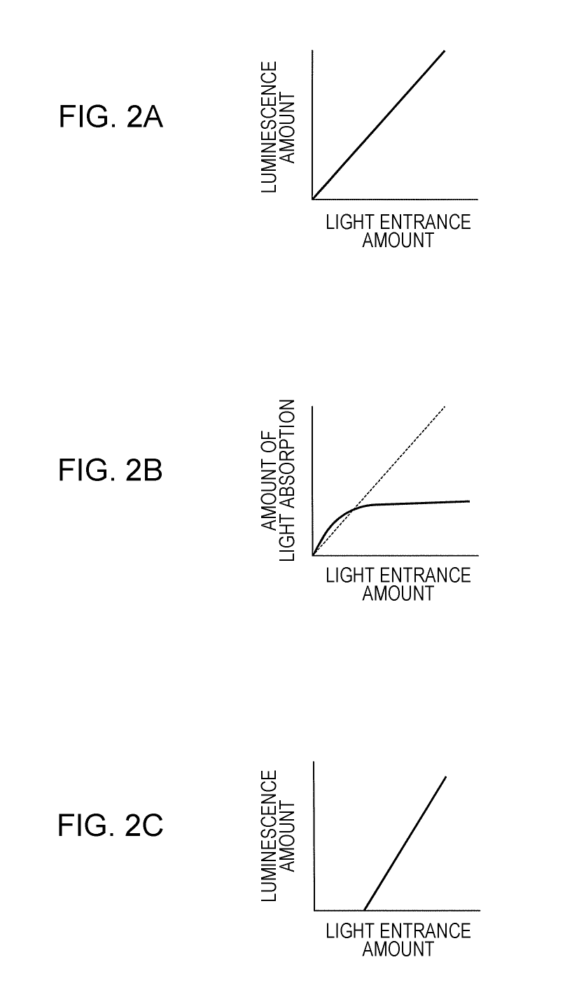

Hereinafter, a light-emitting element according to a first embodiment of the invention will be described with reference to FIGS. 1 and 2A to 2C.

FIG. 1 is a sectional view illustrating the light-emitting element according to the first embodiment. FIGS. 2A to 2C are diagrams illustrating an operation of each layer in the light-emitting element according to the first embodiment. More specifically, FIG. 2A is a graph illustrating characteristics of a fluorescent body, FIG. 2B is a graph illustrating characteristics of an absorption layer, and FIG. 2C is a graph illustrating the characteristics of the entire light-emitting element.

The scales of the dimensions of constituent elements may be different to easily view the respective constituent elements in each drawing described below.

A light-emitting element 1 according to the first embodiment has a configuration in which a light-emitting layer 3 is formed on the upper surface of a substrate 2 (base substrate), as illustrated in FIG. 1. The light-emitting layer 3 has a configuration in which a light absorption layer 4 (light non-transmission amount change material layer) and a fluorescent body layer 5 (fluorescent material layer) are stacked in this order from the substrate side. When excitation light L1 is incident from the lower surface (a surface of an opposite side to the side on which the light-emitting layer 3 is formed) of the substrate 2 in the light-emitting element 1, the excitation light L1 arrives at the fluorescent body layer 5 via the light absorption layer 4. At this time, the fluorescence body in the fluorescent body layer 5 is excited by the excitation light L1, fluorescence is produced, and thus light L2 with a central wavelength on a side of a longer wavelength than the central wavelength of the excitation light is emitted. The ultraviolet light or light with a short-wavelength band of blue light or the like can be used as the excitation light L1.

In the substrate 2, the excitation light L1 from the outside is required to be delivered to the light-emitting layer 3. Accordingly, it is necessary to transmit light at least in the wavelength region of the excitation light L1. Therefore, examples of the material of the substrate 2 include an inorganic material substrate formed of glass, quartz, or the like and a plastic substrate formed of polyethylene terephthalate, polyimide, or the like.

The fluorescent body layer 5 has characteristics in which a luminescence amount linearly increases with an increase in an amount of incident light, illustrated as a relation between the light entrance amount and the luminescence amount of the excitation light L1 in FIG. 2A. In the case of the first embodiment, a layer which absorbs the excitation light L1, when ultraviolet light or blue light is incident as the excitation light L1, and emits the light L2, such as green light or red light, with a wavelength band on the side of the longer wavelength than the wavelength band of the excitation light L1 is used as the fluorescent body layer 5.

The fluorescent body layer 5 may be formed only of a fluorescent body material (first fluorescent material) to be exemplified below, may contain any additive agent or the like, and may be formed such that a fluorescent body material may be dispersed in a bonding material such as a resin material or an inorganic material. A known fluorescent body material can be used as the fluorescent body material of the first embodiment. Such kinds of fluorescent body materials can be classified into organic-based fluorescent body materials and inorganic-based fluorescent body material. The specific compounds will be exemplified below, but the first embodiment is not limited to these materials.

Examples of the organic-based fluorescent body material include, as a fluorescent material converting ultraviolet light or blue light into green light, coumarin-based pigment: 2, 3, 5, 6-1H, 4H-tetrahydro-8-trifluomethyquinolizine (9, 9a, 1-gh) coumarin (coumarin 153), 3-(2′-benzothiazolyl)-7-diethylamino coumarin (coumarin 6), 3-(2′-benzoimidazolyl)-7-N,N-diethylamino coumarin (coumarin 7), naphthalimide pigment: basic yellow 51, solvent yellow 11, and solvent yellow 116. Examples of the organic-based fluorescent body material include, as a fluorescent material converting ultraviolet light or blue light into red light, cyanine-based pigment: 4-dicyanomethylene-2-methyl-6-(p-dimethylaminostyryl)-4H-pyran, pyridine-based pigment; 1-ethyl-2-[4-(p-dymethylaminophenyl)-1,3-butadienyl]-pyridinium Perchlorate and rhodamine-based pigment: rhodamine B, rhodamine 6G, rhodamine 3B, rhodamine 101, rhodamine 110, basic violet 11, and sulforhodamine 101.

Examples of the inorganic-based fluorescent body material include, as a fluorescent material converting ultraviolet light or blue light into green light, (BaMg) Al₁₆O₂₇:Eu²⁺, Mn²⁺, Sr₄Al₁₄O₂₅:Eu²⁺, (SrBa)Al₁₂Si₂O₈:Eu²⁺, (BaMg)₂SiO₄:Eu²⁺, Y₂SiO₅:Ce³⁺, Tb³⁺, Sr₂P₂O₇—Sr₂B₂O₅:Eu²⁺, (BaCaMg)₅(PO₄)₃Cl:E²⁺, Sr₂Si₃O₈-2SrCl₂:Eu²⁺, Zr₂SiO₄, MgAl₁₁O₁₉:Ce³⁺, Tb³⁺, Ba₂SiO₄:Eu²⁺, Sr₂SiO₄:Eu²⁺, and (BaSr)SiO₄:Eu²⁺. Examples of the inorganic-based fluorescent body material include, as a fluorescent material converting ultraviolet light or blue light into red light, Y₂O₂S:EU³⁺, YAlO₃:EU³⁺, Ca₂Y₂ (SiO₄)₆:Eu³⁺, LiY₉(SiO₄)₆O₂:Eu³⁺, YVO₄:Eu³⁺, CaS:Eu³⁺, Gd₂O₃:Eu³⁺, Gd₂O₂S:Eu³⁺, Y (P, V) O₄:Eu³⁺, Mg₄GeO_{5.5}F:Mn⁴⁺, Mg₄GeO₆:Mn⁴⁺, K₅Eu_{2.5} (WO₄)_{6.25}, Na₅Eu_{2.5}(WO₄)_{6.25}, K₅Eu_{2.5} (MoO₄)_{6.25}, and Na₅Eu_{2.5}(MoO₄)_{6.25}.

Emitting fluorescence by miniaturizing CdSe, ZnSe, InP or a semiconductor material such as Si up to a nano-size is known. The visible light is emitted with a size of about 2 nm to about 8 nm. The smaller a grain diameter is, the shorter a luminescence wavelength is.

In the case of the first embodiment, the light absorption layer 4 is formed of a fluorescent body material (second fluorescent material) different from the fluorescent body material forming the fluorescent body layer 5. In this case, the fluorescent body material forming the light absorption layer 4 absorbs the excitation light L1, converts the wavelength of the excitation light L1 into a wavelength band different from a main absorption wavelength band of the fluorescent body layer 5, and then emits light. Specifically, in the case of the first embodiment, a material emitting green light or red light as excitation light of ultraviolet light or blue light is used as the fluorescent body material forming the fluorescent body layer 5. Therefore, a material emitting infrared light as the excitation light L1 of ultraviolet light or blue light is used as the fluorescent body material forming the light absorption layer 4. That is, the luminescent center wavelength of the fluorescent body material forming the light absorption layer 4 is different from the absorptive center wavelength of the fluorescent body material forming the fluorescent body layer 5. The luminescent center wavelength of the fluorescent body material forming the light absorption layer 4 is in the infrared band.

Examples of the inorganic-based fluorescent body material converting ultraviolet light or blue light into infrared light include LiAlO₂: Fe, Al₂O₃: Cr, Cds: Ag, GdAlO₃: Cr, and Y₃Al₅O₁₂: Cr. In a case of CdSe which is a nano-particle fluorescent body, a grain diameter is about 6.3 μm and a luminescent center is 640 nm. Therefore, CdSe can be used for infrared luminescence.

As illustrated in FIG. 2B, the light absorption layer 4 has characteristics in which the light absorption amount increases with an increase in the light entrance amount when the light entrance amount is less than a predetermined light entrance amount, and the light absorption amount is saturated when the light entrance amount is equal to or greater than the predetermined light entrance amount, as a relation between the light entrance amount and the light absorption amount of the excitation light L1. Further, as illustrated in FIG. 2B, the light absorption layer 4 has characteristics of the nonlinearity in the upper convex portion when the horizontal axis represents the light entrance amount and the vertical axis represents the light absorption amount. In order for the light absorption layer 4 to have the characteristics, it is necessary to set a small absorption allowable amount of the excitation light in the light absorption layer 4 with respect to the conceivable maximum value of the light entrance amount of the excitation light L1. As means for realizing the setting, for example, in a case of the light absorption layer in which a kind of fluorescent body material forming the light absorption layer 4 is dispersed in the bonding material, a mixture ratio of the fluorescent body material to the bonding material, the film thickness of the light absorption layer 4, and the like may be appropriately set.

As described above, it is most ideal to use, as the light absorption layer 4, a layer that has the characteristics in which the light absorption amount increases with an increase in the light entrance amount when the light entrance amount is less than the predetermined light entrance amount, and the light absorption amount is saturated when the light entrance amount is equal to or greater than the predetermined light entrance amount. However, the light absorption layer 4 may not necessarily have the characteristics in which the light absorption amount is saturated when the light entrance amount is equal to or greater than the predetermined light entrance amount. When the light absorption layer 4 has characteristics in which a ratio of the light absorption amount to the light entrance amount decreases with the increase in the light entrance amount of the excitation light, the advantage can be obtained at least.

The fluorescent body layer 5 and the light absorption layer 4 can be formed using a solution, in which the above-described fluorescent body material and a resin material are dissolved or dispersed in a solvent, by a known wet process by an application method such as a spin coating method, a dipping method, a doctor blade method, or a spray coating method or a printing method such as an ink jet method, a relief printing method, an intaglio printing method, or a screen printing method, a known dry process such as a resistance heating deposition method, an electron beam (EB) deposition method, a molecular beam epitaxy (MBE) method, a sputtering method, or an organic vapor phase deposition (OVPD) method using the above-described material, a laser transfer method, or the like.

By using a photosensitive resin as the above-mentioned resin material, the fluorescent body layer 5 or the light absorption layer 4 can be patterned by a photolithography method. A compound of one kind or a plurality of kinds of photosensitive resins (light curable resist materials) having a reactive vinyl group, such as an acrylic acid-based resin, a methacrylic acid-based resin, and a hard-gum-based resin can be used as the photosensitive resin. When a known wet process of an ink jet method, a relief printing method, an intaglio printing method, a screen printing method, or the like, a known dry process such as a resistance heating deposition method of using a mask, an electron beam (EB) deposition method, a molecular beam epitaxy (MBE) method, a sputtering method, or an organic vapor phase deposition (OVPD) method, a laser transfer method, or the like described above is used, the fluorescent body material can be directly patterned.

The inventors have found that on the assumption that excitation light leaks in a portion in which light is not to be emitted naturally occur, luminescence does not occur while the light entrance amount of the excitation light is small to some extent and the luminescence occurs when the light entrance amount of the excitation light exceeds a predetermined value. Therefore, the inventors have found that contrasts of a light-emitting unit and a non-light-emitting unit can be ensured when the light-emitting layer has a threshold value in a relation between the light entrance amount and the luminescence amount. As described in the “Technical Problem,” in a case in which such kind of light-emitting element and a liquid crystal element are combined, a black (dark) display state can be maintained in spite of the fact that the contrast of the in-cell polarizing plate is low when the fluorescent body is not excited by leaking light. At this time, the display device can achieve display having contrast greater than the contrast of the in-cell polarizing plate. However, in general, a fluorescent body material does not have a threshold value in the relation between the light entrance amount and the luminescence amount. Accordingly, the inventors have found that the fluorescent body layer can be caused to have a threshold value in a pseudo manner by providing the fluorescent body layer with a light absorption layer having characteristics in which the light absorption amount is saturated when the light entrance amount increases to some extent.

The luminescence intensity of a fluorescent body is known to have a tendency to be saturated or decrease when excitation energy increases (Non-patent literature: Phosphor Handbook by S. Shionoya and W. M. Yen, CRC Press, Boca Raton, Fla., 1998, p. 489 to p 498). In the case of the first embodiment, as described above, the fluorescent body layer 5 basically has characteristics in which the luminescence amount linearly increases with an increase in the light entrance amount as the relation between the light entrance amount and the luminescence amount of excitation light, as illustrated in FIG. 2A. Further, the light absorption layer 4 has characteristics in which the light absorption amount increases with an increase in the light entrance amount, and the light absorption amount is saturated when the light absorption amount is equal to or greater than a predetermined light entrance amount, as a relation between the light entrance amount and the light absorption amount of the excitation light L1, as illustrated in FIG. 2B. Accordingly, in a case in which the fluorescent body layer 5 and the light absorption layer 4 are stacked and the excitation light L1 is emitted from the light absorption layer 4, most of the excitation light L1 is absorbed to the light absorption layer 4 when the light entrance amount of the excitation light L1 is small. Therefore, the excitation light L1 does not reach the fluorescent body layer 5 and the luminescence amount in the fluorescent body layer 5 is very small. When the light entrance amount of the excitation light L1 increases and exceeds than the absorption allowable amount of the light absorption layer 4, the light absorption layer 4 can not absorb the excitation light L1 anymore, and thus the excitation light L1 starts reaching the fluorescent body layer 5. Thus, the luminescence amount sharply increases. FIG. 2C illustrates the characteristics of the light entrance amount and the luminescence amount of the entire stack of the fluorescent body layer 5 and the fluorescent body layer 4. By adopting such a stack configuration, characteristics of the light entrance amount and the luminescence amount can be set to be nonlinear and the threshold value can be given.

Thus, since the black (dark) state can be sufficiently maintained in the non-light emitting region in the light-emitting element 1 according to the first embodiment, high contrast can be obtained. Accordingly, it is very suitable to configure the display device capable of achieving display of high contrast by combining the light-emitting element 1 according to the first embodiment with a liquid crystal element. In particular, in the case of the first embodiment, since the fluorescent body material emitting the infrared light is used as the light absorption layer 4, the infrared light emitted by the light absorption layer 4 is not absorbed by the fluorescent body layer 5 and is emitted to the outside. However, since the infrared light itself is not viewed with eyes and the infrared light does not excite the fluorescent body layer 5, there is no problem with the display and display quality can be maintained.

### Light-Emitting Element According to Second Embodiment

In the above-described first embodiment, the light absorption layer is formed of a fluorescent body material. However, instead of this configuration, the light absorption layer may be formed of a photochromic material. The photochromic material is a material that causes a change of an absorption spectrum in accordance with a chemical change caused by light energy, when the light energy is received. There is an upper limit in the extent of the chemical change of the photochromic material. Therefore, when the light entrance amount is gradually increased, the light absorption amount has a tendency to be saturated or decreased. Various materials are present as the photochromic material. For example, hexa-aryl bis-imidazole in which photochromic reaction occurs at high speed can be used.

Even when the photochromic material is used in the light absorption layer, as in the case in which the fluorescent body material is used, it is necessary to set the absorption allowable amount of the excitation light in the light absorption layer to be smaller than the maximum value of the light entrance amount of the excitation light. Therefore, a kind of photochromic material forming the light absorption layer, the film thickness of the light absorption layer, and the like are appropriately set. Thus, in a case in which the light absorption layer formed of the photochromic material and the fluorescent body layer are stacked and the excitation light is emitted from the side of the light absorption layer, most of the excitation light is absorbed by the light absorption layer when the light entrance amount of the excitation light is small and does not reach the fluorescent body layer. Therefore, the luminescence amount is very small. When the light entrance light of excitation light increases and exceeds the absorption allowable amount of the light absorption layer, all of the excitation light may not be absorbed by the light absorption layer. Therefore, since the excitation light starts reaching the fluorescent body layer, the luminance amount sharply increases. As a result, the light-emitting layer wholly having the nonlinear luminescence characteristics can be obtained.

Even in the case of the second embodiment, it is possible to obtain the same advantages as those of the first embodiment in which the high contrast can be obtained since the black (dark) state can be sufficiently maintained in a non-light emitting region.

### Light-Emitting Element According to Third Embodiment

In the light-emitting element according to the above-described first embodiment, a selection reflection layer may be inserted between a light absorption layer and a fluorescent body layer.

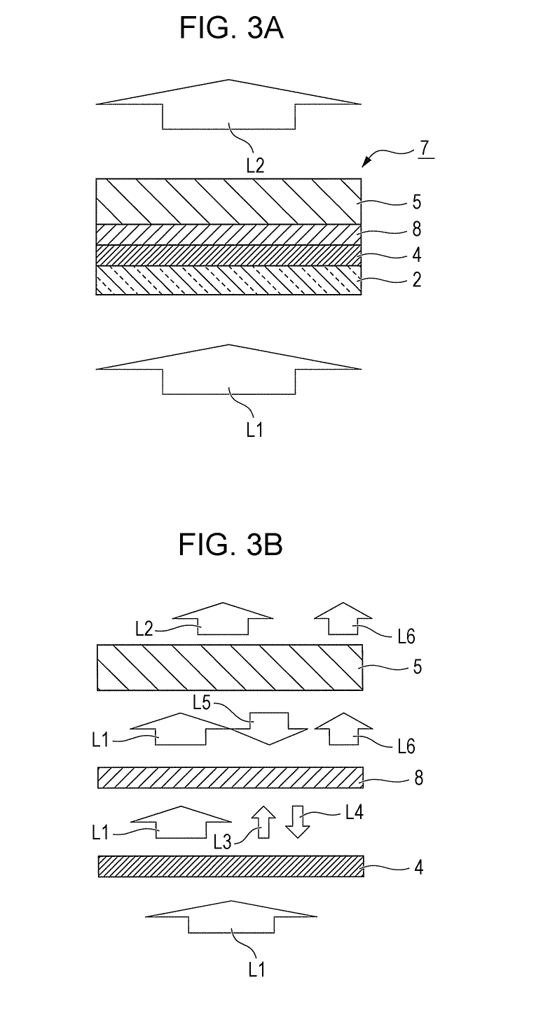

FIG. 3A is a sectional view illustrating a light-emitting element according to a third embodiment. FIG. 3B is a diagram illustrating an operation of each layer in the light-emitting element according to the third embodiment. In the drawings, the same reference numerals are given to constituent elements common to those of FIG. 1 according to the first embodiment, and the detailed description will be omitted.

A light-emitting element 7 according to the third embodiment has a configuration in which a light absorption layer 4 (light non-transmission amount change material layer), a selection reflection layer 8, and a fluorescent body layer 5 (fluorescent material layer) are sequentially stacked on the upper surface of a substrate 2 (base substrate), as illustrated in FIG. 3A. The selection reflection layer 8 has characteristics in which the ultraviolet light or blue light which is excitation light L1 is transmitted and light such as green light, red light, or infrared light having a center wavelength on a longer wavelength side than the center wavelength of the excitation light L1 is at least reflected. The selection reflection layer 8 can be formed of a dielectric multi-layer film or a gold thin film. In the example of FIG. 3A, the selection reflection layer 8 comes into contact with the fluorescent body layer 5 and the light absorption layer 4. However, the selection reflection layer 8 may not necessarily come into contact with the fluorescent body layer 5 or the light absorption layer 4 and may be disposed between the light absorption layer 4 and the fluorescent body layer 5.

Even in the third embodiment, since the black (dark) state can be sufficiently maintained in a non-light emitting region, it is possible to obtain the same advantages as those of the first embodiment in which high contrast can be obtained.

In the case of the third embodiment, as in the above-described first embodiment, the fluorescent body material forming the light absorption layer 4 absorbs the excitation light L1 and emits light L3, as illustrated in FIG. 3B. However, since the selection reflection layer 8 reflect light L4 having a center wavelength on a longer wavelength side than the center wavelength of the excitation light L1, light other than light with the main absorption wavelength of the fluorescent body layer 5 does not reach the fluorescent body layer 5. That is, the luminescence spectrum of the fluorescent body material forming the light absorption layer 4 may have a part of the wavelength band (a part of the longer wavelength side) of the light exciting the fluorescent body layer 5. Accordingly, since there is no problem even when the light produced from the fluorescent body material forming the light absorption layer 4 contains the light having the wavelength band exciting the fluorescent body layer 5, the degree of freedom of selection of the fluorescent body material forming the light absorption layer 4 is improved. Further, the light emitted by the fluorescent body layer 5 is emitted toward all of the directions, but light L5 oriented in the direction of the light absorption layer 4 is reflected from the selection reflection layer 8 and becomes light L6 emitted to the outside. Therefore, an amount of light extracted to the front surface side of the light-emitting element 7 increases, thereby improving light use efficiency.

### Light-Emitting Element According to Fourth Embodiment

The light-emitting element according to the above-described first embodiment may have a stack configuration of a plurality of light absorption layers in which the light absorption layers are formed of different fluorescent body materials.

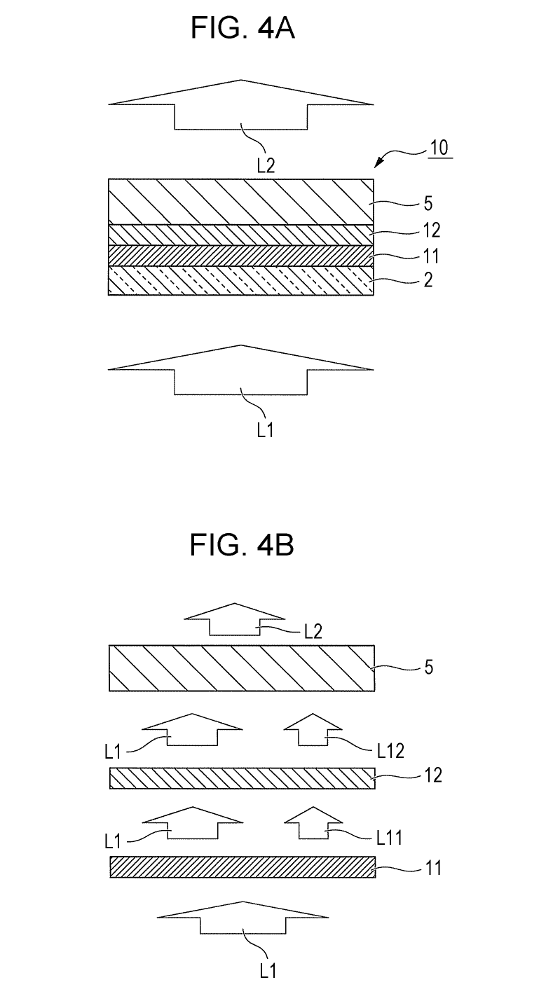

FIG. 4A is a sectional view illustrating a light-emitting element according to a fourth embodiment. FIG. 4B is a diagram illustrating an operation of each layer in the light-emitting element according to the fourth embodiment. In the drawings, the same reference numerals are given to constituent elements common to those of FIG. 1 according to the first embodiment, and the detailed description will be omitted.

In a light-emitting element 10 according to the fourth embodiment, as illustrated in FIG. 4A, a first light absorption layer 11, a second light absorption layer 12, and a fluorescent body layer 5 are sequentially stacked on the upper surface of a substrate 2 (base substrate). Here, as illustrated in FIG. 4B, the first light absorption layer 11 absorbs original excitation light L1 (hereinafter, referred to as first excitation light) and emits light L11 having a wavelength band on a longer wavelength side than the first excitation light L1. Further, the second light absorption layer 12 emits light L12 which is excited by the light L11 (hereinafter, referred to as second excitation light) emitted from the first light absorption layer 11 and has a wavelength band on a longer wavelength side than the second excitation light L11. That is, the first light absorption layer 11 and the second light absorption layer 12 are arranged such that the fluorescent body materials forming the light absorption layers 11 and 12 are lined up from a side close to the incident side of the excitation light to a side distant from the incident side and the luminescence wavelengths are lined up from a shorter wavelength side to a longer wavelength side.

In the case of the fourth embodiment, as in the above-described first embodiment, a kind of fluorescent body material, a film thickness, and the like of the fluorescent body material forming the first light absorption layer 11 are appropriately set and an absorption allowable amount of the excitation light in the first light absorption layer 11 with respect to the maximum value of the light entrance amount of the excitation light L1 is set to be small.

In the light-emitting element 10 according to the fourth embodiment, as described above, the first light absorption layer 11 absorbs the original first excitation light L1 and emits the light L11 having a wavelength band on the longer wavelength side than the first excitation light L1. The second light absorption layer 12 emits the light L12 which is excited by the second excitation light L11 produced from the first light absorption layer 11 and has the wavelength band on the longer wavelength side than the second excitation light L11. Alternatively, the second light absorption layer 12 may absorb a part of the first excitation light L1 and emits light. Thus, even when the light emitted from the first light absorption layer 11 contains the light having the main absorption wavelength band of the fluorescent body layer 5, the light is absorbed by the second light absorption layer 12, and thus does not reach the fluorescent body layer 5. Accordingly, the black (dark) state can be reliably maintained in the non-light emitting region.

Even in the fourth embodiment, since the black (dark) state can be sufficiently maintained in a non-light emitting region, it is possible to obtain the same advantages as those of the first embodiment in which high contrast can be obtained.

The configuration according to the fourth embodiment can be said to be a configuration in which the light absorption layer 4 according to the first embodiment is divided into two layers of the light absorption layers 11 and 12 formed of different fluorescent body materials. In this configuration, even when it is difficult to select an optimum fluorescent body material of the light absorption layer 4 with respect to the fluorescent body material of the fluorescent body layer 5 according to the first embodiment, the material may be optimized through wavelength conversion of two steps. Therefore, the degree of freedom of selection of the fluorescent body material can be improved. In the fourth embodiment, the example in which the light absorption layers of two layers are configured has been described, but three or more layers may be configured. In this case, the degree of freedom of selection of the fluorescent body material can be further improved.

### Light-Emitting Element According to Fifth Embodiment

In the light-emitting element according to the above-described first embodiment, a light absorption layer may be further stacked on the upper surface of the fluorescent body layer.

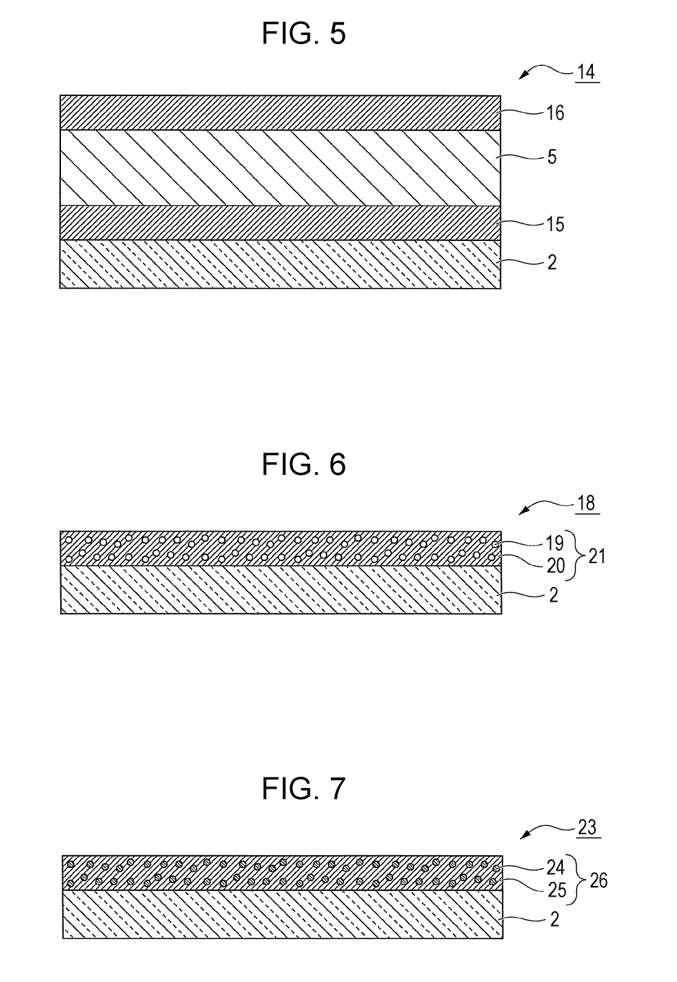

FIG. 5 is a sectional view illustrating a light-emitting element according to a fifth embodiment. In FIG. 5, the same reference numerals are given to constituent elements common to those of FIG. 1 according to the first embodiment, and the detailed description will be omitted.

In a light-emitting element 14 according to the fifth embodiment, as illustrated in FIG. 5, a first light absorption layer 15, a fluorescent body layer 5, and a second light absorption layer 16 are sequentially stacked on the upper surface of a substrate 2 (base substrate). As in the first embodiment, excitation light is also configured to be incident from the lower side of the substrate 2 in the fifth embodiment. In this case, the first light absorption layer 15 close to the substrate 2 suppresses contrast deterioration of the excitation light. The second light absorption layer 16 distant from the substrate 2 suppresses contrast deterioration of outside light.

The first light absorption layer 15 and the second light absorption layer 16 may be formed of the same fluorescent body material or may be formed of different fluorescent body materials in correspondence with a spectrum of the excitation light and a spectrum of the outside light. Alternatively, one or both of the first light absorption layer 15 and the second light absorption layer 16 may be formed of the photochromic material exemplified in the second embodiment.

The light-emitting element 14 according to the fifth embodiment can suppress the contrast deterioration caused by leakage of the excitation light and can also suppress the contrast deterioration caused by the outside light.

Unlike the above-described first embodiment, when it may not be specified whether the excitation light is incident from the lower side of the substrate 2 or the excitation light is incident from the upper side of the substrate 2 as a method of using the light-emitting element 14, the advantage of suppressing the contrast deterioration can be expected irrespective of the incident direction of the excitation light in the light-emitting element 14 according to the fifth embodiment.

### Light-Emitting Element According to Sixth Embodiment

In the light-emitting element according to the above-described first embodiment, the light absorption layer and the fluorescent body layer are divided into two layers, but one layer in which the constituent materials are mixed may be used as a light-emitting layer.

FIG. 6 is a sectional view illustrating a light-emitting element according to a sixth embodiment. In FIG. 6, the same reference numerals are given to constituent elements common to those of FIG. 1 according to the first embodiment, and the detailed description will be omitted.

In a light-emitting element 18 according to the sixth embodiment, as illustrated in FIG. 6, a light-emitting layer 21 in which fluorescent particles 19 are dispersed inside a light absorption layer 20 is formed on the upper surface of a substrate 2 (base substrate). A mixture ratio of the fluorescent particles 19 occupying the light absorption layer 20 may be appropriately set.

Even in the case of the sixth embodiment, since the black (dark) state can be sufficiently maintained in a non-light emitting region, it is possible to obtain the same advantages as those of the first embodiment in which high contrast can be obtained. In particular, in the case of the sixth embodiment, for example, since the light-emitting layer 21 can be collectively formed by preparing a solution in which fluorescent particles 19 are dispersed in the constituent material of the light absorption layer 20 and applying this solution, the manufacturing process can be simplified.

As described in the first to fifth embodiments, it is desirable that the excitation light is incident on the fluorescent body layer after being incident on the light absorption layer, and it is undesirable at that point. On the contrary of the configuration of FIG. 6, a light-emitting layer 26 in which light absorber particles 24 are dispersed inside a fluorescent body layer 25 may be used, as in the light-emitting element 23 illustrated in FIG. 7.

### Light-Emitting Element According to Seventh Embodiment

In the above-described sixth embodiment, the configuration in which the fluorescent particles are dispersed inside the light absorption layer has been adopted. Instead of this configuration, a configuration in which a light absorption layer is coated on the surface of a fluorescent body particle may be used.

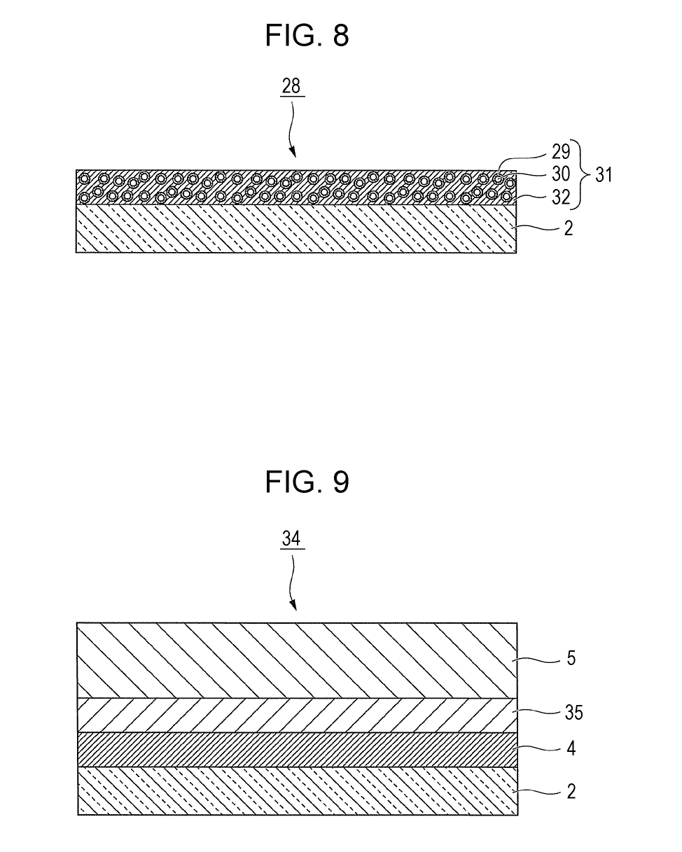

FIG. 8 is a sectional view illustrating a light-emitting element according to a seventh embodiment. In FIG. 8, the same reference numerals are given to constituent elements common to those of FIG. 1 according to the first embodiment, and the detailed description will be omitted.

In a light-emitting element 28 according to the seventh embodiment, as illustrated in FIG. 8, a light-emitting layer 31 in which fluorescent particles 30 having a surface coated with a light absorption layer 29 are dispersed is formed on the upper surface of a substrate 2 (base substrate). The fluorescent particles 30 are dispersed in a bonding material 32 formed of an organic material or an inorganic material having a transmission property for excitation light or fluorescent emitted light.

Even in the seventh embodiment, since the black (dark) state can be sufficiently maintained in a non-light emitting region, it is possible to obtain the same advantages as those of the first embodiment in which high contrast can be obtained. In particular, in the case of the seventh embodiment, even when the incident direction of the excitation light may not be specified, the advantage of suppressing the contrast deterioration can be expected irrespective of the incident direction of the excitation light.

### Light-Emitting Element According to Eighth Embodiment

A layer in which a constituent material of a fluorescent body layer and a constituent material of a light absorption layer are mixed may be combined with the configurations according to the above-described first to seventh embodiments.

FIG. 9 is a sectional view illustrating a light-emitting element according to an eighth embodiment. In FIG. 9, the same reference numerals are given to constituent elements common to those of FIG. 1 according to the first embodiment, and the detailed description will be omitted.

In a light-emitting element 34 according to the eighth embodiment, as illustrated in FIG. 9, a light absorption layer 4, a fluorescent body and light absorber mixed layer 35, and a fluorescent body layer 5 are sequentially stacked on the upper surface of a substrate 2 (base substrate). The layers with the configurations illustrated in FIGS. 6 to 8 can be used as the fluorescent body and light absorber mixed layer 35.

Even in the eighth embodiment, since the black (dark) state can be sufficiently maintained in a non-light emitting region, it is possible to obtain the same advantages as those of the first embodiment in which high contrast can be obtained.

### Display Device According to Tenth Embodiment

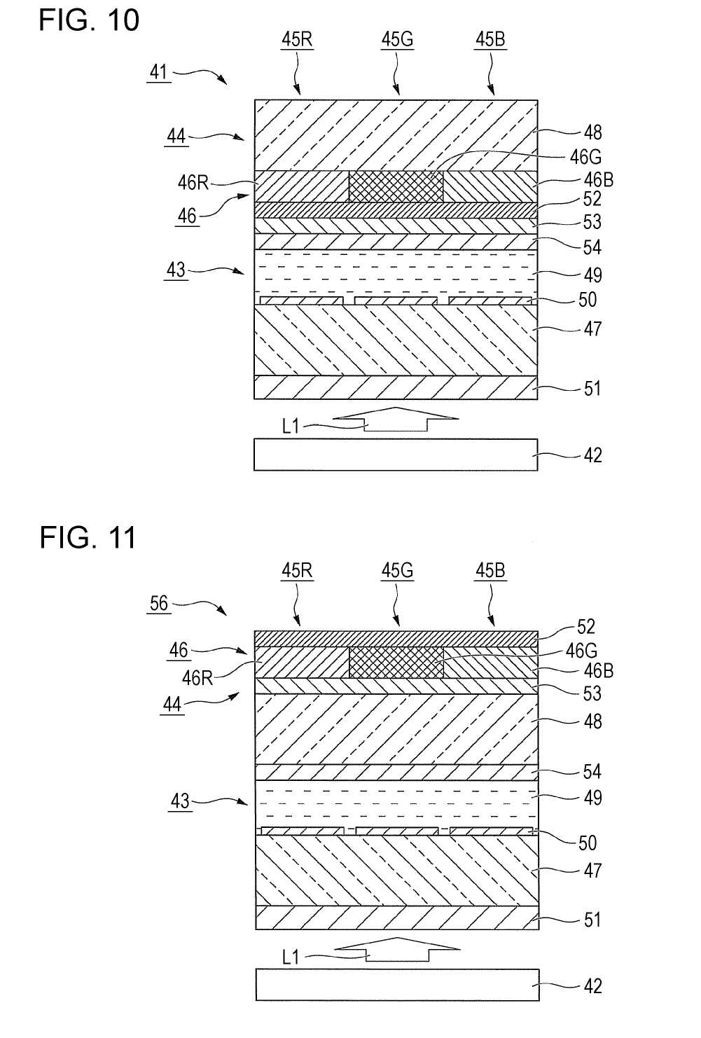

Hereinafter, a display device according to a tenth embodiment of the invention will be described with reference to FIG. 10.

In the tenth embodiment, a display device configured such that a liquid crystal element is combined with the light-emitting element according to the above-described first to ninth embodiments will be exemplified.

FIG. 10 is a sectional view illustrating the display device according to the tenth embodiment.

A display device 41 according to the tenth embodiment includes a backlight 42 (light source), a liquid crystal element 43 (light modulation element), and a light-emitting element 44 having the configuration according to the above-described embodiment, as illustrated in FIG. 10. In the display device 41 according to the tenth embodiment, a red sub-pixel 45R performing display of red light, a green sub-pixel 45G performing display of green light, and a blue sub-pixel 45B performing display of blue light are adjacently disposed. One pixel which is the minimum unit realizing display is formed by the three sub-pixels 45R, 45G, and 45B.

The backlight 42 emits excitation light L1 exciting fluorescent body layers 46R, 46G, and 46B of the light-emitting element 44. In the tenth embodiment, the backlight 42 emits the ultraviolet light or blue light as the excitation light L1. The liquid crystal element 43 modulates the transmittance of the excitation light L1 emitted from the backlight 42 for each of the above-described sub-pixels 45R, 45G, and 45B. The excitation light L1 modulated by the liquid crystal element 43 is incident on the light-emitting element 44, the fluorescent body layers 46R, 46G, and 46B are excited, and thus fluorescent light is emitted to the outside. Accordingly, in the tenth embodiment, the upper side of the display device 41 illustrated in FIG. 10 is a visible side on which a user views display.

The liquid crystal element 43 has a configuration in which a liquid crystal layer 49 is interposed between a first transparent substrate 47 and a second transparent substrate 48. In the case of the tenth embodiment, the second transparent substrate 48 located on the front surface side, when viewed from the user, also serves as a substrate of the light-emitting element according to the above-described first to ninth embodiments. A first transparent electrode 50 is formed for each sub-pixel on the inner surface (the surface on the side of the liquid crystal layer 49) of the first transparent substrate 47 and an alignment film (not illustrated) is formed to cover the first transparent electrode 50. A first polarizing plate 51 is formed on the outer surface (the opposite surface to the side of the liquid crystal layer) of the first transparent substrate 47. A substrate formed of, for example, glass, quartz, or plastic and capable of transmitting the excitation light can be used as the first transparent substrate 47.

A transparent conductive material such as indium tin oxide (hereinafter, abbreviated to ITO) is used in the first transparent electrode 50. An externally attached polarizing plate which is conventional and general can be used as the first polarizing plate 51.

On the other hand, a fluorescent body layer 46 described in the above-described first to ninth embodiments and a light absorption layer 52 are stacked in this order from the substrate side on the inner surface (the surface on the side of the liquid crystal layer 49) of the second transparent substrate 48. In the fluorescent body material forming the fluorescent body layer 46, a luminescence wavelength band is different for each sub-pixel. When the excitation light from the backlight 42 is the ultraviolet light, the fluorescent body layer 46R formed of a fluorescent body material that absorbs the ultraviolet light and emits red light is formed in the red sub-pixel 45R, the fluorescent body layer 46G formed of a fluorescent body material that absorbs the ultraviolet light and emits green light is formed in the green sub-pixel 45G, and the fluorescent body layer 46B formed of a fluorescent body material that absorbs the ultraviolet light and emits blue light is formed in the blue sub-pixel 45B.

Alternatively, when the excitation light from the backlight 42 is blue light, fluorescent body layers formed of fluorescent body materials that absorb the ultraviolet light and emit red light and green light are formed in the red sub-pixel 45R and the green sub-pixel 45G, respectively, and a light diffusion layer diffusing and emitting the blue light which is the excitation light to the outside without wavelength conversion of the blue light is formed in the blue sub-pixel 45B instead of the fluorescent body layer. Further, a second polarizing plate 53 is formed on the inner surface of the second transparent substrate 48 so as to cover the light absorption layer 52, and a second transparent electrode 54 and an alignment film (not illustrated) are stacked on the surface of the second polarizing plate 53. The second polarizing plate 53 is a polarizing plate produced by an application technology or the like during a process of manufacturing the liquid crystal element 43 and is a so-called in-cell polarizing plate. A transparent conductive material such as ITO is used in the second transparent electrode 54, as in the first transparent electrode 50.

A type of the liquid crystal element 43 is not particularly limited. For example, an active matrix type in which a switching element such as a thin film transistor (hereinafter, abbreviated to TFT) is provided in each sub-pixel may be used or a passive matrix type in which no TFT is provided may be used. Further, the mode of the liquid crystal layer 49 is not particularly limited. Various liquid crystal modes such as a TN (Twisted Nematic) mode, a VA (Vertical Alien) mode, and an IPS (In-Plane Switching) mode may be adopted.

Next, before the advantages of the display device 41 according to the tenth embodiment is described, the problems of display devices according to the related art and a comparative example will be described with reference to the drawings.

FIG. 13 is a sectional view illustrating a display device 100 according to the related art described in PTL 2 which is one of the patent literatures. In FIG. 13, reference numeral 101 denotes a backlight, reference numerals 102 and 103 denote polarizing plates, reference numerals 104 and 105 denote transparent substrates, reference numerals 106 and 107 denote transparent electrodes, reference numeral 108 denote a liquid crystal layer, and reference numerals 109R, 109G, and 109B denote fluorescent body layers.

As illustrated in FIG. 13, in the display device 100 according to the related art, the polarizing plate 103 is disposed on the front surface side of the transparent substrate 105. The fluorescent body layers 109R, 109G, and 109B are disposed on the front surface side of the polarizing plate 103. Here, for example, even when the liquid crystal layer 108 is controlled such that a red sub-pixel enters the ON state (bright display) and a green sub-pixel enters the OFF state (dark display), a sum plate thickness of the transparent substrate 105 and the polarizing plate 103 is sufficiently thick with respect to the size of the sub-pixels. Therefore, light transmitting obliquely through the red sub-pixel may arrive at the green sub-pixel. As a result, the fluorescent body is excited in the green sub-pixel which has to be originally in the OFF state (dark display) and the green sub-pixel enters the ON state (bright display) in some cases.

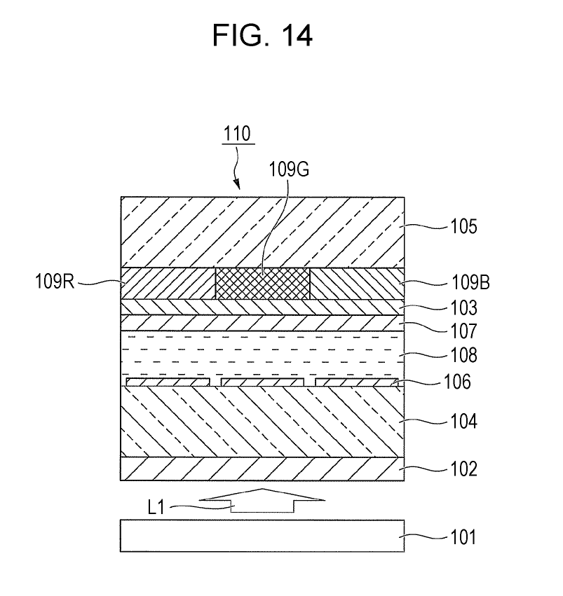

A display device considered as means for resolving the above-described problem is a display device according to the comparative example illustrated in FIG. 14. In FIG. 14, the same reference numerals are given to constituent elements common to those of FIG. 13. A display device 110 according to the comparative example illustrated in FIG. 14 is different from the display device 100 according to the related art illustrated in FIG. 13 in that fluorescent body layers 109R, 109G, and 109B and a polarizing plate 103 are disposed on the rear surface side (the side of a liquid crystal layer 108) of a transparent substrate 105. However, in the case of the polarizing plate 103 formed on the transparent substrate 105 during a process of manufacturing the liquid crystal element, as in the display device 110, a problem arises in that sufficient contrast may not be obtained due to the restriction on a polarizing plate material.

On the other hand, the display device 41 according to the tenth embodiment illustrated in FIG. 10 is different from the display device 110 according to the comparative example illustrated in FIG. 14 in that the light absorption layer 52 is formed on the rear surface side (the side of the liquid crystal layer 49) of the fluorescent body layer 46. The characteristics of the light entrance amount and the luminescence amount of the light absorption layer 52 is nonlinear and the threshold value is provided. Therefore, even when the contrast of the second polarizing plate 53 is low and the excitation light L1 is slightly leaked to a sub-pixel that has to perform the dark display (non-lighting), the leaked light is absorbed by the light absorption layer 52. On the other hand, since most of the excitation light L1 arrives at the fluorescent body layer 46 in a sub-pixel that has to perform the bright display (lighting) without absorption by the light absorption layer 52, it is possible to obtain the same bright display as that of a case in which the light absorption layer 52 is not provided. Accordingly, it is possible to prevent the contrast deterioration since the excitation light L1 in the sub-pixel which has to perform the dark display (non-lighting) arrives at the fluorescent body layer 46 and the dark display is brightened. Thus, according to the tenth embodiment, there is no problem of the erroneous lighting caused by parallax. Even when the contrast of the polarizing plate is low, the display device with the sufficient contrast can be realized.

### Display Device According to Eleventh Embodiment

Hereinafter, a display device according to an eleventh embodiment of the invention will be described with reference to FIG. 11.

The basic configuration of the display device according to the eleventh embodiment is the same as that of the display device according to the tenth embodiment. The positions of a polarizing plate, fluorescent body layers, and a light absorption layer are different from those of the first embodiment.

FIG. 11 is a sectional view illustrating a display device according to an eleventh embodiment. In FIG. 11, the same reference numerals are given to constituent elements common to those of FIG. 10 according to the tenth embodiment, and the detailed description will be omitted.

In a display device 56 according to the eleventh embodiment, as illustrated in FIG. 11, a second polarizing plate 53, fluorescent body layers 46R, 46G, and 46B, and a light absorption layer 52 are stacked in this order from the substrate side on the outer surface side of a second transparent substrate 48. A second transparent electrode 54 is formed on the inner surface side of the second transparent substrate 48. The other configuration is the same as that of the tenth embodiment.

In the display device of a fluorescent body excitation type, the existence of outside light has a side influence on display. That is, erroneous lighting may occur in which the fluorescent body layer is excited by the ultraviolet light or blue light contained in the outside light and a portion that is to be originally darkly displayed may be turned on, or contrast may deteriorate. However, in the display device 56 according to the eleventh embodiment, the light absorption layer 52 is disposed on the outermost surface off the display device 56. Therefore, since the ultraviolet light or blue light contained in the outside light is absorbed by the light absorption layer 52, the ultraviolet light or blue light does not arrive at the fluorescent body layers 46R, 46G, and 46B. Thus, according to the eleventh embodiment, it is possible to realize the display device capable of maintaining high contrast without the influence of the outside light.

### Display Device According to Twelfth Embodiment

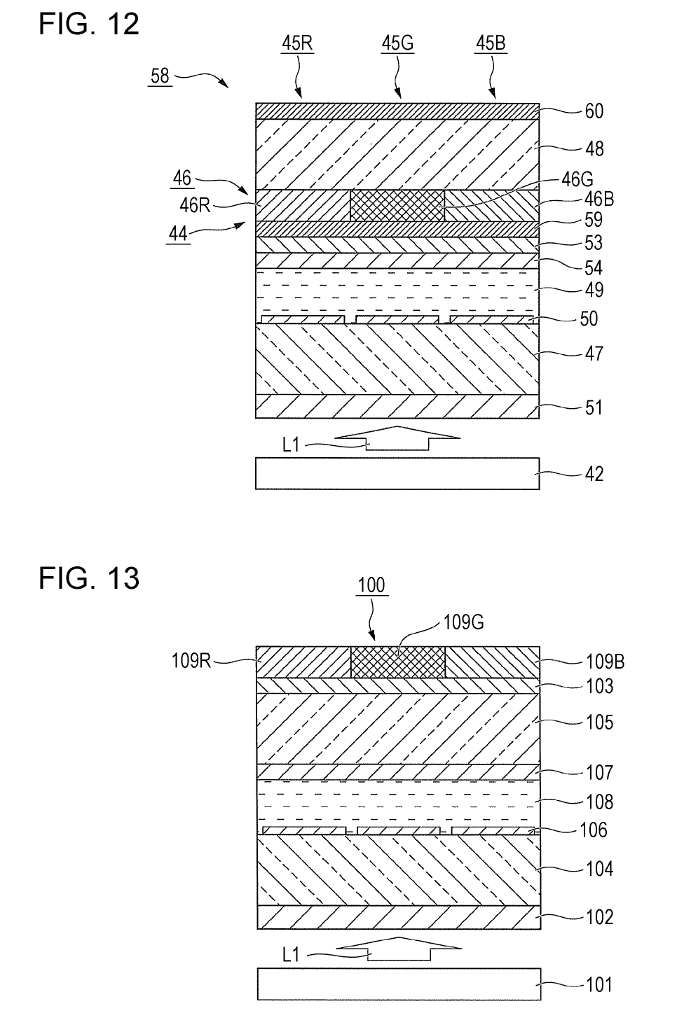

Hereinafter, a display device according to a twelfth embodiment of the invention will be described with reference to FIG. 12.

The basic configuration of the display device according to the twelfth embodiment is the same as that of the display device according to the tenth embodiment and is different from that of the first embodiment in that one layer is further added as the light absorption layer.

FIG. 12 is a sectional view illustrating a display device according to a twelfth embodiment. In FIG. 12, the same reference numerals are given to constituent elements common to those of FIG. 10 according to the tenth embodiment, and the detailed description will be omitted.

In a display device 58 according to the twelfth embodiment, as illustrated in FIG. 12, fluorescent body layers 46R, 46G, and 46B, a first light absorption layer 59, a second polarizing plate 53, and a second transparent electrode 54 are stacked in this order from the substrate side on the inner surface side of a second transparent substrate 48. Further, a second light absorption layer 60 is formed on the outer surface side of the second transparent substrate 48. The first light absorption layer 59 suppresses contrast deterioration caused by leakage of excitation light L1 from a backlight 42. The second light absorption layer 60 suppresses contrast deterioration caused by outside light. The first light absorption layer 59 and the second light absorption layer 60 may be formed of the same fluorescent body material or may be formed of different fluorescent body materials suitable for the excitation light and the outside light, respectively. The other configuration is the same as that of the tenth embodiment.

In the display device 58 according to the twelfth embodiment, the first light absorption layer 59 and the second light absorption layer 60 are formed on the inner surface side and the outer surface side of the second transparent substrate 48, respectively. Therefore, there is no problem of the erroneous lighting caused by parallax. Even when the contrast of the second polarizing plate 53 (in-cell polarizing plate) used in an environment in which outside light is present is low, the display device capable of maintaining the sufficient high contrast can be realized.

The technical scope of the invention is not limited to the above-described first to twelfth embodiments, but various modifications can be made within the scope of the invention without departing from the gist of the invention. For example, in the above-described first to twelfth embodiments, the fluorescent body material having the characteristics in which the light absorption amount increases with an increase in the light entrance amount and the light absorption amount is saturated when the light entrance amount exceeds a predetermined light entrance amount has been exemplified and the light absorption layer formed of a photochromic material has been exemplified. Instead of the light absorption layer, for example, a light reflection layer which is formed of a photochromic material and has characteristics in which a light reflection amount increases with an increase in the light entrance amount and the light reflection amount is saturated when the light entrance amount exceeds a predetermined light entrance amount may be used in the invention. When the light reflection layer has the characteristics in which the light reflection amount is saturated when the light entrance amount exceeds the predetermined light entrance amount, the light reflection layer is an ideal layer. However, when the light reflection layer has characteristics in which a ratio of the light reflection amount to the light entrance amount decreases with an increase in the light entrance amount, the advantage can be obtained at least. The light non-transmission amount change material layer controlling the light entrance amount to the fluorescent body layer may be formed of not only a fluorescent body material or a photochromic material but also another material having characteristics in which a ratio of the light absorption amount or the light reflection amount to the light entrance amount decreases with an increase in the light entrance amount.

In the above-described first to twelfth embodiments, the display device in which the light-emitting element according to the above-described first to twelfth embodiments is combined with the liquid crystal element has been exemplified. Instead of this configuration, the display device may be configured by combining the light-emitting element according to the above-described first to twelfth embodiments with a light modulation element such as an organic electroluminescence (EL) element, a plasma display (PDP), a cold-cathode tube (CRT), or a surface-conduction electron-emitter display (SED). Further, the light-emitting element according to the invention can be used in, for example, an electron signboard device or an illumination device, and thus can be used for uses other than the display device.

### INDUSTRIAL APPLICABILITY

The present invention is applicable to various display devices such as a liquid crystal display device, an organic electroluminescence display device, and a plasma display or various kinds of fields of an illumination device and the like.

### REFERENCE SIGNS LIST

1, 7, 10, 14, 18, 23, 28, 34, 44: light-emitting element
2: substrate (base substrate)
3, 21, 26, 31: light-emitting layer
4, 20, 29, 52: light absorption layer (light non-transmission amount change material layer)
5, 25, 46, 46R, 46G, 46B: fluorescent body layer (fluorescent material layer)
8: selection reflection layer
11, 15, 59: first light absorption layer
12, 16, 60: second light absorption layer
19, 30: fluorescent particle
24: light absorber particle
35: fluorescent body and light absorber mixed layer
41, 56, 58: display device
42: backlight (light source)
43: liquid crystal element (light modulation element)

1. A light-emitting element comprising:
a base substrate; and
a light-emitting layer that is formed on the base substrate,
wherein the light-emitting layer includes at least
a fluorescent material that absorbs excitation light with a predetermined wavelength band and produces light with a wavelength band different from the predetermined wavelength band, and
a light non-transmission amount change material that has characteristics in which a ratio of a light non-transmission amount to a light entrance amount of excitation light decreases with an increase in the light entrance amount,
wherein the light non-transmission amount change material is disposed on an excitation light incident side of at least the fluorescent material, and
wherein the light non-transmission amount change material is formed of a photochromic material.

2. The light-emitting element according to claim 1, wherein the light non-transmission amount change material has characteristics in which the light non-transmission amount increases with an increase in the light entrance amount when the light entrance amount is less than a predetermined light entrance amount, and the light non-transmission amount is saturated when the light entrance amount is equal to or greater than the predetermined light entrance amount.

3. (canceled)

4. The light-emitting element according to claim 1,
wherein the light non-transmission amount change material is formed of a second fluorescent material different from the first fluorescent material, when the fluorescent material is assumed to be a first fluorescent material, and
wherein a luminescence center wavelength of the second fluorescent material is different from an absorption center wavelength of the first fluorescent material.

5. The light-emitting element according to claim 4, wherein the luminescence center wavelength of the second fluorescent material is present in an infrared band.

6. The light-emitting element according to claim 4,
wherein the second fluorescent material is formed of a plurality of fluorescent materials including different materials, and
wherein the plurality of fluorescent materials are arranged from a side close to a light incident side to a side distant from the light incident side such that luminescence wavelengths of the fluorescent materials are lined up from a shorter wavelength side to a longer wavelength side.

7. (canceled)

8. The light-emitting element according to claim 1, wherein a selection reflection layer that transmits the excitation light and at least reflects light having a center wavelength on a longer wavelength side than a center wavelength of the excitation light is disposed between the fluorescent material and the light non-transmission amount change material.

9. The light-emitting element according to claim 1,
wherein a fluorescent material layer including the fluorescent material and a light non-transmission amount change material layer including the light non-transmission amount change material are stacked on at least one surface of the base substrate, and
wherein the light-emitting layer is formed by two layers of the fluorescent material layer and the light non-transmission amount change material layer.

10. The light-emitting element according to claim 1,
wherein a first fluorescent material layer including the fluorescent material, a light non-transmission amount change material layer including the light non-transmission amount change material, and a second fluorescent material layer including the fluorescent material are stacked on at least one surface of the base substrate, and
wherein the light-emitting layer is formed by three layers of the first fluorescent material layer, the light non-transmission amount change material layer, and the second fluorescent material layer.

11. The light-emitting element according to claim 1, wherein a light-emitting layer in which a fluorescent particle formed of the fluorescent body is dispersed inside the light non-transmission amount change material is formed on at least one surface of the base substrate.

12. The light-emitting element according to claim 1, wherein a light-emitting layer including a fluorescent particle in which a surface of the fluorescent body is covered with the light non-transmission amount change material is formed on at least one surface of the base substrate.

13. A display device comprising:
a light source that emits excitation light;
a light modulation element that modulates the excitation light emitted from the light source; and
a light-emitting element on which the excitation light modulated by the light modulation element is incident,
wherein the light-emitting element includes
a base substrate, and
a light-emitting layer that is formed on the base substrate, and
wherein the light-emitting layer includes at least
a fluorescent material that absorbs excitation light with a predetermined wavelength band and produces light with a wavelength band different from the predetermined wavelength band, and
a light non-transmission amount change material that has characteristics in which a ratio of a light non-transmission amount to a light entrance amount of excitation light decreases with an increase in the light entrance amount.

14. The display device according to claim 13, wherein the light modulation element includes a liquid crystal element that is able to adjust optical transmittance of each predetermined region by applying an electric field.

15. The display device according to claim 14,
wherein the light-emitting element is disposed such that a surface on which the light-emitting layer is formed faces a side of the liquid crystal element, and
wherein a polarizing plate is disposed between the light-emitting element and the liquid crystal element.

16. The display device according to claim 13,
wherein the light-emitting element includes a fluorescent material layer and a light non-transmission amount change material layer, and
wherein the light non-transmission amount change material layer is disposed on an excitation light incident side of the fluorescent material layer.

17. The display device according to claim 13,
wherein the light-emitting element includes a fluorescent material layer and a light non-transmission amount change material layer, and
wherein the light non-transmission amount change material layer is disposed on an outside light incident side of the fluorescent material layer.
